(19) United States
(12) Patent Application Publication
(10) Pub. No.: US 2025/0016608 A1
(43) Pub. Date: Jan. 9, 2025

(54) DELAY TOLERANT DATA OBJECT TRANSMISSION

(71) Applicant: Telefonaktiebolaget LM Ericsson (publ), Stockholm (SE)

(72) Inventors: Edgar RAMOS, KIRKKONUMMI (FI); Ari KERÄNEN, HELSINKI (FI)

(21) Appl. No.: 18/707,682

(22) PCT Filed: Oct. 31, 2022
(86) PCT No.: PCT/SE2022/050989

§ 371 Date: May 6, 2024

Related U.S. Application Data
(60) Provisional application No. 63/276,831, filed on Nov. 8, 2021.

(51) Int. Cl. H04W 28/02; H04W 28/06; H04W 28/082

(52) U.S. Cl. CPC H04W 28/0268; H04W 28/065; H04W 28/082

(57) ABSTRACT

A method performed by a first network node for transmitting a data object to a second network node via a network. The method includes obtaining at least one of the following items: i) information indicating the size of the data object, ii) network state information for the network, or iii) state information for the second network node. The method also includes determining, based on the obtained information, at least one of the following: i) a delay tolerant, DT, configuration for the transmission of the data object, wherein the determined DT configuration comprises a set of parameter values, or ii) a schedule for the transmission of the data object. The method further includes transmitting the data object to the second network node based on a) the determined DT configuration and/or b) the determined schedule.

### TECHNICAL FIELD

Disclosed are embodiments related to the transmission of a data object from a first network node to a second network node.

### BACKGROUND

In some use cases, a first network node, such an Internet-of-Things (IoT) device or a “constrained device” as defined in Internet Engineering Task Force (IETF) Request for Comments (RFC) 7228 or other network node, may need to transmit, via a network comprising a radio access network (RAN), a large data object (e.g., data object comprising more than 1 Megabyte (MB) of data) to an application server (AS) connected to the Internet. Similarly, in some use cases, the AS may need to transmit a large data object to the first network node via the RAN. Also, there are scenarios where one or more ASs may need to transmit a large data object (e.g., file having a size greater than 1 MB) to many network nodes (e.g., dozens or hundreds) at roughly the same time and via the same RAN access point (e.g., base station).

In such use cases, the network may need a support mechanism to handle the traffic load peaks that are pushed by the application servers, which don't have any knowledge of the network load or IoT device power saving activity configuration.

Narrow band IoT (NB-IoT) is a technology that allows IoT devices to transmit/receive user data via control plane messages (e.g., Non-Access Stratum (NAS) messages). This is known as “Data Over NAS” (DONAS). DONAS is intended for transmission of small sized data objects. Accordingly, DONAS is not suited for certain applications, such as providing a software update to an IoT device because the software update typically comprises a large data object.

The IETF RFC 8724 defines a Static Context Header Compression and Fragmentation (SCHC) framework, which provides both a header compression mechanism and an optional fragmentation mechanism. According to RFC 8724, “SCHC has been designed with Low-Power Wide Area Networks (LPWANs) in mind.”

SCHC compression is based on a common static context (i.e., a set of Rules) stored both in the LPWAN device and in the network infrastructure side. The SCHC header compression and fragmentation mechanisms are independent of the specific LPWAN technology over which they are used. SCHC compression uses a context in which information about header fields is stored. This context is static: the values of the header fields and the actions to do compression/decompression do not change over time. This avoids the need for complex resynchronization mechanisms. In most cases, a small rule identifier (ID) is enough to represent the full Intern Protocol version 6 (IPv6) header and/or the User Datagram Protocol (UDP) headers.

Some LPWAN technologies do not provide a fragmentation functionality; to support the IPV6 maximum transmission unit (MTU) requirement of 1280 bytes, they require a fragmentation protocol at the adaptation layer below IPV6. Therefore, SCHC has been designed to provide such fragmentation in order to support transmission in smaller chunks with the compressed IP headers and even additional transport or session protocols.

From the SCHC specification, the high-level functionality is described as follows:

SCHC can be characterized as an adaptation layer between an upper layer (for example, IPv6) and an underlying layer (for example, an LPWAN technology). SCHC comprises two sublayers, the Compression sublayer and the Fragmentation sublayer on top of the LPWAN technology MAC and in between IP (which is in top). Before an upper layer packet (e.g., an IPV6 packet) is transmitted to the underlying layer, header compression is first attempted. The resulting packet is called an “SCHC Packet,” whether or not any compression is performed. If needed by the underlying layer, the optional SCHC fragmentation may be applied to the SCHC Packet. The inverse operations take place at the receiver.

SCHC offers fragmented packet corruption detection, and delivery reliability window-based mechanisms, such as ACK-always (each fragment delivery is explicitly acknowledged) and ACK-on Error (only detected losses trigger delivery reports outlining the fragment loss).

The compression is based on a static context. The context delivery to the peers is out of scope of the protocol itself, but the server side requires a device identification that maps to a context for that device. Both receiver and transmitter must have the same context information so they can use a simple dictionary indexing (rules) and additional matching operators for variable fields to map them to the pre-agreed rules and being able to decompress the packets in the receiver side with minimum use of parameters used to be applied to the indicated rule operators.

The fragmentation allows transmissions of packets bigger than the MTU of the LPWAN. There are three reliability modes for fragment delivery. Compression and fragmentation are decoupled processes, meaning that one does not depend on the other and they may or may not be executed for each packet (e.g., there could be compression without fragmentation and there could be fragmentation without compression).

As noted above, a context is a collection of SCHC rules. The rules are targeting the headers of the expected packet (i.e., several rules may map to the same protocols). The network requires to identify the device originating the packets when decompressing. A device ID is required together with the context. If no eligible rule is found, then the header must be sent without compression.

Currently, SCHC hasn't been mandated for 3rd Generation Partnership (3GPP) networks, therefore it can be used up to now as an over-the-top protocol, from the application server to the terminal application. An NB-IoT profile is currently in draft state on the LPWAN group (see Ramos, E., “SCHC over NB-IoT,” Ipwan Working group, Internet-Draft Oct. 22, 2021 (available at datatracker (dot) ietf (dot) org/doc/html/draft-ietf-lpwan-schc-over-nbiot). The draft explains several ways of how to utilize SCHC with cellular 3GPP networks, including the over-the-top option.

### SUMMARY

Certain challenges presently exist. For example, the currently existing transport/transfer protocols implemented in devices using cellular technologies do not allow reliable, delay tolerant transmission of data objects. For instance, using DONAS for data transfer is vulnerable to high loads caused by large data object transfers such as, for example, firmware updates, and causes disturbances to the whole network because signaling storms caused by protocol timeouts (e.g., TCP timeouts), retransmissions, and the timing of the data transfers in reference to concurrent data transmission operations targeting a single site. Additionally, the current state of SCHC does not consider the fragmentation of data objects, but instead only the fragmentation of IP packets. Fragmentation in the RAN is normally not needed since this is taken care by the radio protocols and therefore the fragmentation feature of SCHC was not originally intended to be used in a RAN.

Accordingly, there is provided a method performed by a first network node for transmitting a data object to a second network node via a network. In one embodiment the method includes the first network node obtaining i) information indicating the size of the data object, ii) network state information for the network (e.g., network load information and/or information indicating the amount of available resources), and/or iii) state information for the network node (e.g., a power savings configuration). The method also includes the first network node determining, based on the obtained information, at least one of the following: 1) a delay tolerant (DT) configuration for the transmission of the data object, wherein the determined DT configuration comprises a set of parameter values, or 2) a schedule for the transmission of the data object. The method also includes the first network node transmitting the data object to the network node based on i) the determined DT configuration and/or ii) the determined schedule.

In another embodiment, the method includes the first network node determining the size of the data object and transmitting to the second network node a first message indicating the determined size of the data object. The method also includes the first network node receiving a second message transmitted by the second network node, the second message indicating a delay tolerant (DT) configuration for the transmission of the data object, wherein the indicated DT configuration comprises a set of parameter values. The method further includes the first network node transmitting the data object to the second network node based on the indicated DT configuration.

There is also provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium.

There is also provided a network node that is configured to perform the methods disclosed herein. In some embodiments, the network node comprises a storage unit and processing circuitry coupled to the storage unit, wherein the network node is configured to perform the methods disclosed herein.

An advantage of the embodiments disclosed herein is that they provide reliable, delay tolerant transmissions of large data objects.

### BRIEF DESCRIPTION OF THE DRAWINGS

The accompanying drawings, which are incorporated herein and form part of the specification, illustrate various embodiments.

FIG. 1 illustrates a communication system according to an embodiment.

FIG. 2 illustrates an example use case environment.

FIG. 3 is a message flow diagram illustrating a process according to some embodiments.

FIG. 4 is a message flow diagram illustrating a process according to some embodiments.

FIG. 5 is a message flow diagram illustrating a process according to some embodiments.

FIG. 6 is a flowchart illustrating a process according to some embodiments.

FIG. 7 is a flowchart illustrating a process according to some embodiments.

FIG. 8 is a block diagram of a network node according to some embodiments.

### DETAILED DESCRIPTION

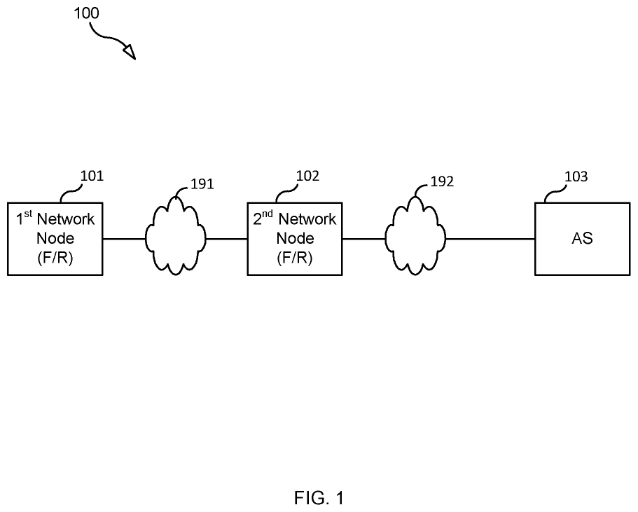

FIG. 1 illustrates a communication system 100 according to an embodiment. Communication system 100 includes a first network node (NN) 101, a second NN 102, and an application server (AS) 103 (a.k.a., “host” 103). NN 101 communicates with NN 102 via a network 191, which may include a 3GPP RAN, and NN 102 communicates with AS 103 via a network 192, which may include the Internet. In this example, NN 101 and NN 102 both utilize a fragmentation and reassembly (F/R) function. For example, NN 101 and NN 102 may implement the F/R SCHC protocol layer defined in RFC 8724 or a variant thereof.

Advantageously, NN 101 and NN 102 provide for a delay tolerant data object transmissions over network 191. In one embodiment, this is achieved by: (1) dividing the data object into chunks (a.k.a., fragments) (i.e., some continuous portion of the data object); (2) determining a delay toleration (DT) configuration that identifies a set of optimized protocol layer (e.g., SCHC layer) parameters that control, for example, the fragmentation of the data (e.g., protocol data units (PDUs) containing the data) and their transmission expiration timers (e.g., an inactivity timer and/or a retransmission timer) and (3) using the DT configuration to transmit the chunks of the data object.

In one embodiment, the determination of the DT configuration is based on: (1) a state (e.g., actual state or expected state) of network 191 (e.g., the current or expected traffic load of network 191, the availability of resources within network 191, etc.), (2) a state of the network node to which the data object is being transmitted (e.g., the current or expected power saving configuration of the network node), (3) the size of the data object to be transmitted, or (4) any combination of (1), (2), and (3).

In one embodiment, determining the DT configuration includes selecting a DT configuration from a set of pre-configured DT configurations, wherein each pre-configured DT configuration identifies the protocol layer parameters, and wherein the selection is based on the traffic load of the network, the state of the network node to which the data object is being transmitted, and/or the size of the data object to be transmitted.

In an embodiment in which the data object is being transmitted from NN 101 to AS 103, NN 101 is provided with a best effort transmission interval (BETI) to pace the transmission of the chunks of the data object. For example, NN 102 (or another network node) may determine the BETI value based on a desired behavior and/or the expected availability of resources within network 191.

The embodiments described herein avoid problems related to loss of synchronization due to delayed transmissions of acknowledgements from reliable data transmission protocols such as, for example, the Transmission Control Protocol (TCP). Using TCP, in many cases, exacerbates the problem by increasing the already heavy traffic load by adding retransmission to the transmission queue even when the original packet has been timeout but it hasn't yet been transmitted (still in the transmission buffer).

In one embodiment, a large data object is divided into smaller chunks (a.k.a., fragments) that are then transmitted according to the determined DT configuration. For instance, in an embodiment where AS 103 has a large data object to transmit to NN 101, AS 103 transmits the data object to NN 102, which then fragments the data object into chunks and transmits the chunks to NN 101 in accordance with a selected DT configuration. NN 101 then reassembles the chunks, thereby obtaining the data object. Similarly, when NN 101 has a large data object to transmit to AS 103, NN 101 fragments the data object and transmits the chunks to NN 102 according to a selected DT configuration. NN 102 then reassembles the chunks to obtain the data object and provides the data object to AS 103.

As noted above, prior to the transmission of the data object, NN 101 or NN 102 selects a DT configuration for use in transmitting the chunks of the data object. The network node that selects the DT configuration may transmit to the other node a DT configuration ID (e.g., an SCHC rule ID or other ID) that identifies the selected DT configuration. In some embodiments, one or more SCHC rule IDs can identify the same DT configuration. The DT configuration ID (DTC-ID) may be transmitted in-band (i.e., with a chunk) or out-of-band (e.g., using the Radio Resource Control (RRC) protocol, Network Configuration (NETCONF) protocol, etc.).

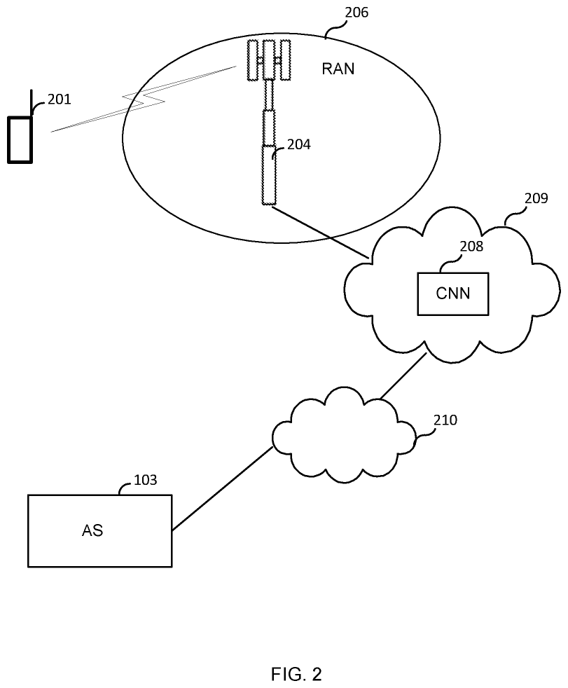

FIG. 2 illustrates an example use case. More specifically, FIG. 2 illustrates a communication system 200 according to an embodiment. Communication system includes: a user equipment (UE) 201, an access point (AP) 204 of a radio access network (RAN) 206 (e.g., a 3GPP base station), a core network node (CNN) 208 within a core network 209 (e.g., a 3GPP core network), and AS 103 connected to core network 209 via a network 210 (e.g., the Internet or other packet data network). As used herein a “UE” is any device (e.g., mobile phone, router, sensor, appliance, vehicle, constrained device, smart object, smart device, actuator, smart meter, etc.) capable of wireless communication with access point 204.

In this use case, UE 201 corresponds to NN 101 and either AP 204 or CNN 208 corresponds to NN 102. CNN 208 can be any core network node that has access to the user plane or control plane (e.g., Service Capability Exposure Function (SCEF), Network Exposure Function (NEF), Packet Data Network Gateway (P-GW), Mobility Management Entity (MME), User Plane Function (UPF), etc.).

A challenge that the embodiments herein address is how best to configure the fragmentation and reassembly (F/R) functions (e.g., SCHC F/R functions) in the F/R endpoints NN 101 and NN 102 (e.g., SCHC endpoints) with the relevant DT configuration for a particular scenario so the transmitter (e.g., NN 102) and the receiver (e.g., NN 101) both have an understanding of what are the parameters of operation, which depends on: (1) a state of network 191 (e.g., the current or expected traffic load of network 191), (2) a state of the network node to which the data object is being transmitted (e.g., the current or expected power saving configuration of the network node), (3) the size of the data object to be transmitted, or (4) any combination of (1), (2), and (3). Network load is variable and dynamic. Accordingly, there could be times when the network is congested and other times when it is idle. Moreover, the network load can change suddenly due to a peak of traffic. A network node's power saving state is less dynamic (although a device can be re-configured with several configurations). Accordingly, here the main challenge is the diversity of devices and their capabilities which means that each device will have a particular configuration and they also require a particular configuration of parameters that match the power saving settings of the device to optimize the battery savings and fit well the traffic patterns planned for the network.

### Scheduling a Large Data Object Transfer—Network Initiated

In some scenarios, one or more network nodes (e.g., NN 102) may receive a number of requests to transfer a large data object to another network nodes (e.g., NN 101) where these other network nodes are served by the same AP (e.g. AP 204). In one embodiment, to accomplish this, NN 102 needs to have a copy of the large object to be delivered to NN 101 to transmit it to NN 101 according to a suitable scheduling and agreed DT configuration. In one embodiment, NN 102 provides an application programming interface (API) to enable AS 103 to upload the data object to NN 102 or a proxy (e.g., a Hypertext Transfer Protocol (HTTP) proxy), for large object transfers that would buffer the data object for further transmission. The delivery of the data object from NN 102 to NN 101 may reuse the current mechanisms used to provide IP tunneling transmissions or non-IP transmissions.

### Scheduling a Large Data Object Transfer—Non-Network Initiated

When NN 101 is onboarded into the network 100, or during a network connection procedure (e.g., an RRC connection establishment procedure), NN 101 is configured with a threshold data object size value (MAX_OBJECT_SIZE) measured in bytes which NN 101 uses to determine whether or not to transmit the object using a DT configuration.

For example, if the size of the data object to be transmitted exceeds MAX_OBJECT_SIZE, then NN 101 will determine that it needs to use a DT configuration to transmit the data object to AS 103 and it should utilize the most adequate DT configuration capable to handle the transmission of the data object. The most adequate DT configuration is one that can handle data objects having a size greater than or equal to the size of the data object to be transmitted.

In the case were NN 101 does not have a suitable DT configuration, NN 101 may send to NN 102 a request message (e.g., a large data object transmission (LDOT) request message) indicating the size of the data object to be transmitted. This message could be an RRC message, a Network Configuration Protocol (NETCONF) message, or other control plane protocol message, and it may use a pre-defined data schema (e.g., YANG).

In response to the LDOT request message, NN 102 may transmit to NN 101 a configuration update message containing a suitable DT configuration (e.g., a new SCHC context including suitable rules) that matches the object size requested and an indication that such DT configuration is marked for uplink purposes. Alternatively, NN 102 may send a reject message indicating that such large data object transmission is not allowed at the current time (e.g., NN 102 may be in a severely resource constrained state).

In some embodiments, NN 101 may be configured with an additional threshold value (denoted DELAY_TOLERANT_THRESHOLD_SIZE). In this embodiment, even when NN 101 is equipped with a DT configuration that can serve the size of the data object to be transmitted, if the size of the data objects exceeds DELAY_TOLERANT_THRESHOLD_SIZE, then, to get permission to initiate the transfer of the data object, NN 101 must first send to NN 102 an LDOT request message indicating the S>DELAY_TOLERANT_THRESHOLD_SIZE, where S is the size of the data object to be transmitted. NN 102 responds to the request by transmitting a response message that: (1) informs NN 101 that it may proceed with the transmission using a DT configuration selected by NN 101; (2) contains a new DT configuration and informs NN 101 that it may proceed with the transmission using the new DT configuration selected by NN 102; or (3) informs NN 101 that it may not at this time proceed with the transmission of the data object (in this scenario the response message may include a timer value indicating a time at which the device may re-attempt the same request).

In some embodiments, the DT configurations provided to NN 101 by NN 102 may each include a Best Effort Transfer Interval (BETI) parameter value that identifies an minimum interval of time between the transmission of a particular fragment of the data object and the transmission of the next fragment of the data object. Hence, the BETI value enables NN 102 to provide pacing information to NN 101. Generally, after transmitting a fragment message (e.g., an SCHC Fragment message that contains a Fragment Header and Fragment Payload—see, e.g., RFC 8724 at FIG. 12) containing a chunk of the data object, NN 101 does not transmit another fragment message containing a chunk of the data object until after the interval identified by the BETI has passed. The value of BETI could be based on: i) a timer (send new fragment message every X seconds), ii) transmission occasions (send a new fragment message every X occasion), or iii) radio events (paging, DRX/DTX cycle, etc.). In some embodiments the value of the BETI can be also determined by a random timer given by a configured range.

In embodiments where the F/R entity is an SCHC F/R entity, a DT configuration may include a Tile Count (TC) parameter that indicates the number of SCHC tiles that must be included in the fragment message. If the DT configuration does not have a TC parameter, then NN 101 can set the value to a default value (e.g., 1).

In case of several DT configurations being available to transmit the data object, NN 101 may choose the DT configuration with the lowest absolute values of the parameters to initiate the transmission. NN 102 may also provide the DT configurations with a priority value that may be followed by NN 101, where the highest priority should be attempted first. In some embodiments, the DTC-ID identifying a DT configuration also function as the priority value. The UL transmission from NN 101 to NN 102 may utilize the same uplink mechanisms used for IP tunnelling and non-IP transmissions already specified for cellular networks.

### Selecting a DT Configuration

In the embodiment were NN 102 is transmitting the data object to NN 101, once NN 102 has information on the data object size as well as other information (e.g., current or planned traffic), NN 102 can estimate the load generated in a site (e.g., the load at AP 204) and determine a schedule (e.g., how to partition the data object, when to send each part of it, etc.) and/or a DT configuration to maintain preferred utilization of the network resources. The determination would take in account also the power saving configuration of the targeted device (i.e. NN 101) (e.g., the configuration that defines when NN 101 is able to send or receive data due to power saving sleep cycles).

In one embodiment, a set of DT configurations are predefined, where each different DT configurations comprises a set of parameter values and is identified by a DT configuration ID (DTC-ID). This is useful in embodiments implemented using SCHC because SCHC works with static context information. For example, at least three different DT configurations may be predefined, where each configuration is associated with a size indicator (e.g., small, medium, and large). For instance, the network could configure: a first DT configuration for small data objects (e.g., data objects greater than or equal to 1 MB but less than or equal to 10 MB), a second DT configuration for medium data objects (e.g., data objects greater than 10 MB but less than 1 GB), and a third DT configuration for large data objects (e.g., data objects greater than or equal to 1 GB). In another embodiment, at least six different DT configures are predefined: a first DT configuration for small data objects and network load below or equal to a load threshold (L); a second DT configuration for small data objects and network load>L; a third DT configuration for medium data objects and network load<=L; a fourth DT configuration for medium data objects and network load>L; a fifth DT configuration for large data objects and network load<=L; and a sixth DT configuration for large data objects and network load>L.

For example, based on the calculations of expected and desired load (in terms of bitrates to be handled per device) and the size of the data object to be transmitted, NN 102 may select a particular one of the predefined DT configurations.

In one embodiment, each DT configuration enables a fragmentation mode and, if it is desired to have at least a minimum reliability, it may be preferable for each DT configuration to enable the ACK-on-Error mode (i.e., in this mode NN 101 does not ACK each fragment). Because a mobile network (e.g., 3GPP RAN) has a reliability mechanism, it could help with a very little overhead to provide additional reliability for cases when connectivity has been lost or is very sporadic, due to, for example, bad network coverage or high interference environments. The ACK-always setting provides even higher reliability but it also introduces additional overhead. For the cellular type of communication, ACK-on-Error provides typically enough reliability support.

In an SCHC embodiment, each DT configuration sets the size of the SCHC tiles used to fragment the data object to the maximum transmission unit (MTU) size of the bearer where the transmission will be realized, for example, in the case of Data over NAS (DoNAS), the maximum MTU would be 1358 Bytes.

An inactivity timer and a retransmission timer (e.g., the SCHC inactivity timer and retransmission timer) can be also set according to the scheduling calculation and the expected time of delivery for the large packets. Those timers are applied to the fragments that are transmitted and their acknowledgements. NN 102 can use the expected scheduling time and set several parameters according to multiple scheduling situations, for example, highly congested, congested, medium load, small load, no load. For each of these scheduling conditions, NN 102 may determine a DT configuration matching the load preferred to be generated for each of the situations. For example, in a highly congested environment, the load per data object transmission is preferred to be kept very low (so as not to reach the maximum capacity for the network and potentially keeping a safety margin to allow for unexpected high priority traffic), meaning that the packet transmission can be delayed and retransmission requests should not be sent too soon, and, therefore, the retransmission timer and the inactivity timer may be set to a very high value (e.g., 24 hours). In contrast, in a low load situation, the timers would be set to a significantly smaller value (e.g., 10 minutes). The values of the timers may also be correlated to the SCHC window (i.e., successive tiles in a group) size, which translates on how many transmissions of the tiles are expected in order to check the correct reception of the tiles belonging to one window. Shorter timers would correspond to shorter window size (i.e., smaller number of tiles would be sent, and hence shorter retransmission/inactivity time is appropriate), meanwhile larger timer values would correspond to larger window size. The window size would also depend on how many tiles the data object is fragmented into. Another parameter value that can be set is the ACK timer.

In some embodiments, each DT configuration would also have information in reference to the maximum number of attempts (i.e., meaning how many retransmissions of one packet (after the retransmission timer has expired) should be attempted before aborting the transmission). In cases of devices with a history of bad coverage (known from, e.g., connectivity logs for that device), this setting could be set to a higher number (for example 10) and in more common cases for a cellular network, where reliability is high, to just one retransmission. Similarly, if the uplink channel has a poor quality, then the adjustment could be done in the MAX_ACK_REQUESTS, where the sender would poll the receiver to transmit a bitmap with the received packets if needed and retransmit the request if the retransmit timer expires.

### Updating the DT Configurations

In some cases, none of the predefined DT configurations match the scheduling that NN 102 would prefer to provide for the transmission of the data object. In such a case, NN 102 (or another network node) may provide to NN 101 a new DT configuration to add to the already existing set of DT configurations. This configuration update can be done using, for example, an RRC message or other control plane protocol.

### DT Configuration Example

The table below identifies the one or more parameter values that may be included in a DT configuration:

DTC-ID (ID for the identifying the DT Configuration, this ID may also
function as a priority value)
Priority (priority of the configuration, not needed when DTC-ID functions
a priority value)
Best_Effort_Transfer_Interval (BETI - how often the transmission will
be done in the uplink. Not including BETI or setting BETI to a Zero value
could be used to signal that the DT configuration is for downlink only)
SCHC MAX_PACKET_SIZE (max size of the object that is handled by
the configuration)
TILES_SIZE (Size of tiles used to fragment object using SCHC
fragmentation)
TILES_COUNT (Tiles transmitted per BETI - optional)
Inactivity timer (a Fragment receiver uses this timer to abort waiting for a
Fragment message)
Retransmission timer (a Fragment sender uses this timer to abort waiting
for an expected SCHC ACK)
WINDOW_SIZE (Size of the window used to keep a set of fragments
(e.g., SCHC fragments) over the air at once over the air at once that the
receiver and transmitter keep track of reception)
MAX_ACK_REQUEST (Maximum number of ACK timer expirations
before aborting transmission with error)
MAC Logical Channel mapping (Mapping to a logical channel ID to
signal the configuration in use)
Rule_Set (Sets of Rules that apply to this configuration. Each rule has a
Rule Id. In case of using Rule Id to signal the DT configuration in use,
each rule Id should be unique through all the configurations)
Permission Flag (if flag is set to 1, then the network node must request
permission before transmitting the data object, otherwise permission is not
needed)
MAX_OBJECT_SIZE
DELAY_TOLERANT_THRESHOLD_SIZE

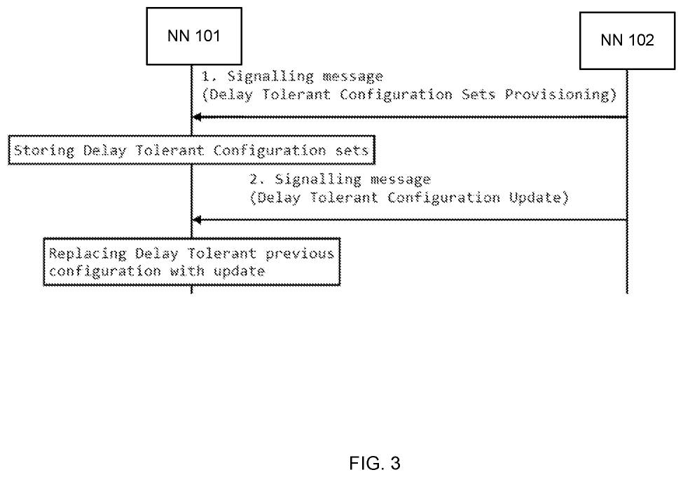

FIG. 3 is a message flow diagram, according to an embodiment, illustrating the provisioning and updating of DT configurations. In this example, NN 102 transmits to NN 101 a set of DT configurations. NN 101 stores the DT configurations. At some later point in time, NN 102 may send to NN 101 an update message comprising an updated DT configuration to replace an existing DT configuration and/or a new DT configuration). If the update message includes an updated DT configuration, NN 101 determines the DTC-ID included in the updated DT configuration and replaces the existing DT configuration that has the same DTC-ID.

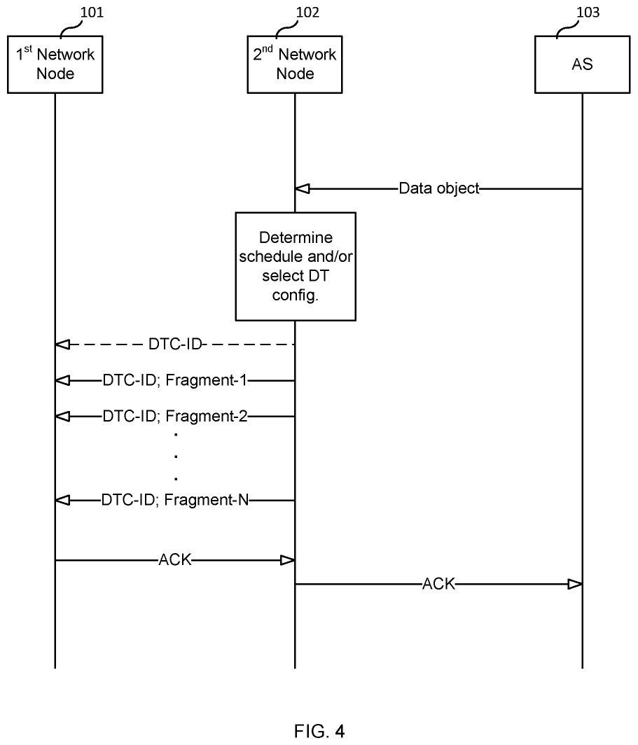

FIG. 4 is a message flow diagram, according to an embodiment, illustrating the transmission of a data object from AS 103 to NN 101 via NN 102. As shown in FIG. 4, the data transmission process may begin with AS 103 providing the data object to NN 102. Based on a number of factors described above (e.g., state of network 191, state of NN 101, the size of the data object, etc.), NN 102 determines a schedule for the transmission of the data object and/or a DT configuration for the transmission of the data object.

In some embodiments, after determining (e.g., selecting) a DT configuration for the transmission of the data object NN 102 initiates transmitting to NN 101 an out-of-band message comprising the DTC-ID that identifies the selected DT configuration. The out-of-band message may be an RRC message. For example, in embodiments where NN 101 is implemented by UE 201 and NN 102 is implemented by CNN 208, CNN 208 may transmit to AP 204 a message comprising the DTC-ID and this message triggers AP 204 to transmit to UE 201 an RRC message comprising the DTC-ID.

As shown in FIG. 4, NN 102 transmits N fragment messages to NN 101. Each fragment message may include a chunk of the data object. NN 102 may transmit the fragment messages according to the schedule that it determined. For example, NN 102 may have determined a schedule that specifies that NN 102 will transmit at least one fragment message every X seconds (or every X transmission opportunities). In one embodiment, each fragment message may include the DTC-ID (i.e., any ID that is mapped to the selected DT configuration). In other embodiments, only the first fragment message includes the DTC-ID. In still other embodiments in which the DTC-ID is provided to NN 101 using an out-of-band message, none of the fragment messages include the DTC-ID.

In some embodiments, the fragment messages are SCHC fragment messages, which include a Rule ID. In some embodiments, the Rule ID is set to the DTC-ID so that the Rule ID identifies the determined DT configuration. In other embodiments, NN 101 has mapping that maps the Rule ID to a DT configuration. For instance, as shown above, a DT configuration may include a Rule Set that contains a set of Rule IDs wherein each Rule ID in the set is mapped to the DT configuration containing the Rule Set. In some embodiments, the fragment messages (or portions thereof) are encapsulated within a layer 2 PDU (e.g., Medium Access Control (MAC) PDU) and the layer 2 PDU has a header that contains an ID mapped to the determined DT configuration. For instance, a MAC PDU may have a logical channel ID and this logical channel ID is mapped to the determined DT configuration. For instance, as shown above, a DT configuration may have a MAC Logical Channel mapping parameter for mapping a MAC logical channel ID to the DT configuration.

In the example shown in FIG. 4, NN 101 does not transmit an ACK after successfully receiving each fragment message. Rather, NN 101 is configured to transmit an ACK only after an error is encountered or after successfully receiving all N of the fragment messages. This ACK behavior may be specified in the determined DT configuration.

In one embodiment, after receiving a particular fragment message (denoted fragment message i), NN 101 may activate a timer that is set to expire after a particular amount of time has elapsed. This particular amount of time may be specified by the inactivity timer value included in the selected DT configuration. If the timer expires before a subsequent fragment message i+1 is received, then NN 101 may inform NN 102 that an error has occurred.

As shown in FIG. 4, after NN 102 receives from NN 101 the final ACK indicating that NN 101 has successfully received the entire data object (i.e., all N of the fragment messages), NN 102 informs AS 103 that the data object has been successfully delivered to NN 101.

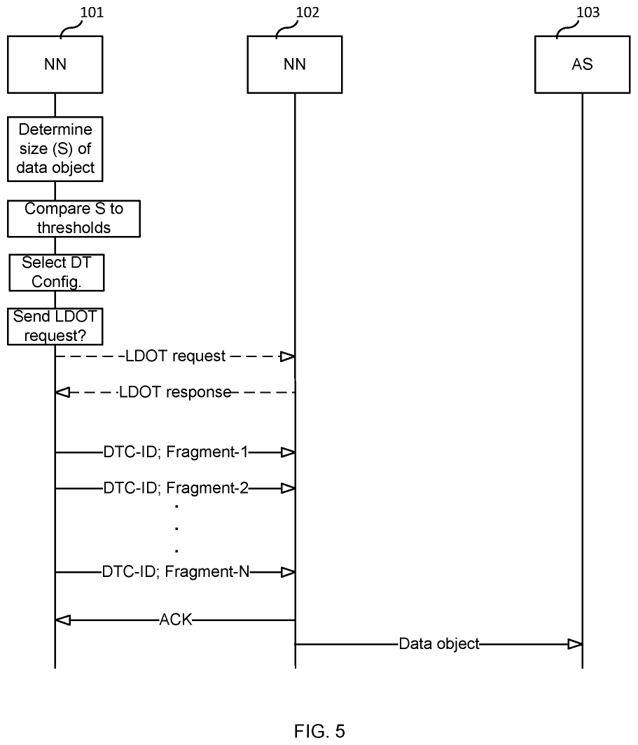

FIG. 5 is a message flow diagram, according to an embodiment, illustrating the transmission of a data object from NN 101 to AS 103 via NN 102. The process for transmitting the data object may begin with NN 101 determining the size(S) of the data object (S is measured in bytes). Next, NN 101 may compare S to one or more thresholds. For example, in one embodiment, NN 101 compares S to MAX_OBJECT_SIZE. As a result of determining that S is greater than MAX_OBJECT_SIZE, then NN 101 will attempt to determine a DT configuration for the transmission of the data object (e.g., NN 101 may attempt to choose from among a set of preconfigured DT configurations a DT configuration suitable for the data object). Next, NN 101 determines whether or not to send an LDOT request to NN 102. For example, if NN 101 does not have a preconfigured DT configuration that is suitable for the transmission of the data object, then NN 101 transmits to NN 102 an LDOT request message indicating that NN 101 needs a DT configuration. As another example, NN 101 will transmit to NN 102 an LDOT request message indicating that S is greater than the DELAY_TOLERANT_THRESHOLD_SIZE (the LDOT request message may also include the DTC-ID of a DT configuration selected by NN 101). As yet another example, NN may be configured to always send to NN 102 an LDOT request message or other out-of-band message (e.g. RRC message, NETCONF message, etc.) whenever S is greater than MAX_OBJECT_SIZE; in this scenario the LDOT request message or other out-of-band message may include the DTC-ID of the DT configuration selected by NN 101.

After transmitting the LDOT request message, NN 101 receives an LDOT response message transmitted by NN 102. The LDOT response message may: a) include a DCT-ID identifying a DT configuration that NN 102 has selected and that should be used for the transmission of the data object, b) include a DT configuration that NN 102 has selected and that should be used for the transmission of the data object, or c) an indication that NN 101 should not at this time initiate the transmission of the data object (in this case the response message may include a wait time and after the wait time expires then NN 101 can retransmit the LDOT request message). Additionally, if the LDOT request message included a DTC-ID, then the LDOT response message may include an indicator that NN 102 agrees that NN 101 should use the identified DT configuration when transmitting the data object. Also, the LDOT response message may include a BETI value to be used by NN 101 when transmitting the data object.

After receiving the LDOT response message, if any, and assuming that NN 101 is permitted to proceed with the transmission of the data object, NN 101 transmits N fragment messages to NN 102. Each fragment message may include a chunk of the data object. NN 101 may transmit the fragment messages according to a schedule determined by NN 102 (e.g., according to a BETI value provided in the LDOT response message or the BETI value included in the determined DT configuration). For example, NN 102 may have determined a BETI value that specifies that NN 101 should not transmit more than one fragment message every X seconds (or every X transmission opportunities) and NN 102 may have provided this BETI value to NN 101. In one embodiment, after receiving the N fragment message, NN 102 transmits an ACK to NN 101 and transmits the data object to AS 103. In some embodiments, NN 102 transmits the data object to AS 103 by transmitting the data object to a proxy (e.g., an HTTP proxy) that will then forward the data object to AS 103.

In one embodiment, each fragment message may include the DTC-ID of the DT configuration that NN 101 is using to transmit the data object. In other embodiments, only the first fragment message includes the DTC-ID. In still other embodiments in which the DTC-ID is provided to NN 102 using an out-of-band message (e.g., the LDOT request message), none of the fragment messages include the DTC-ID.

In some embodiments, the fragment messages are SCHC fragment messages, which include a Rule ID. In some embodiments, the Rule ID is set to the DTC-ID so that the Rule ID identifies the determined DT configuration. In other embodiments, NN 102 has mapping that maps the Rule ID to a DT configuration. For instance, as shown above, a DT configuration may include a Rule Set that contains a set of Rule IDs wherein each Rule ID in the set is mapped to the DT configuration containing the Rule Set. In some embodiments, the fragment messages (or portions thereof) are encapsulated within a layer 2 PDU (e.g., MAC PDU) and the layer 2 PDU has a header that contains an ID mapped to the determined DT configuration. For instance, a MAC PDU may have a logical channel ID and this logical channel ID is mapped to the determined DT configuration. For instance, as shown above, a DT configuration may have a MAC Logical Channel mapping parameter for mapping a MAC logical channel ID to the DT configuration.

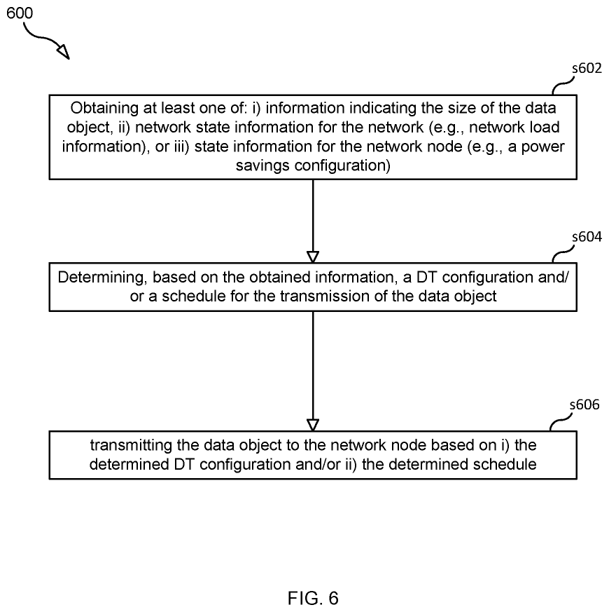

FIG. 6 is a flowchart illustrating a process 600, according to an embodiment, for transmitting a data object to a network node (e.g., NN 101 or NN 102) via a network (e.g., network 191). Process 600 may begin in step s602.

Step s602 comprises obtaining at least one of the following: i) information indicating the size of the data object, ii) network state information for the network (e.g., network load information and/or information indicating the amount of available resources), or iii) state information for the network node (e.g., a power savings configuration).

Step s604 comprises, based on the obtained information, determining: 1) a delay tolerant, DT, configuration for the transmission of the data object, wherein the determined DT configuration comprises a set of parameter values, and/or 2) a schedule for the transmission of the data object.

Step s606 comprises transmitting the data object to the network node based on i) the determined DT configuration and/or ii) the determined schedule.

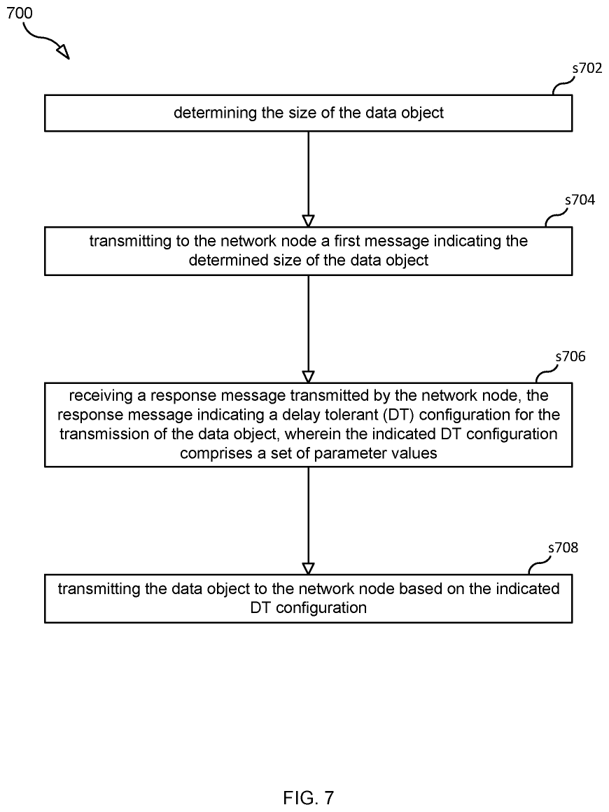

FIG. 7 is a flowchart illustrating a process 700, according to an embodiment, for transmitting a data object to a network node (e.g., NN 102) via a network (e.g., network 191). Process 700 may begin in step s702.

Step s702 comprises determining the size of the data object.

Step s704 comprises transmitting to the network node a first message indicating the determined size of the data object.

Step s706 comprises receiving a second message transmitted by the network node, the second message indicating a DT configuration for the transmission of the data object, wherein the indicated DT configuration comprises a set of parameter values.

Step s708 comprises transmitting the data object to the network node based on the indicated DT configuration.

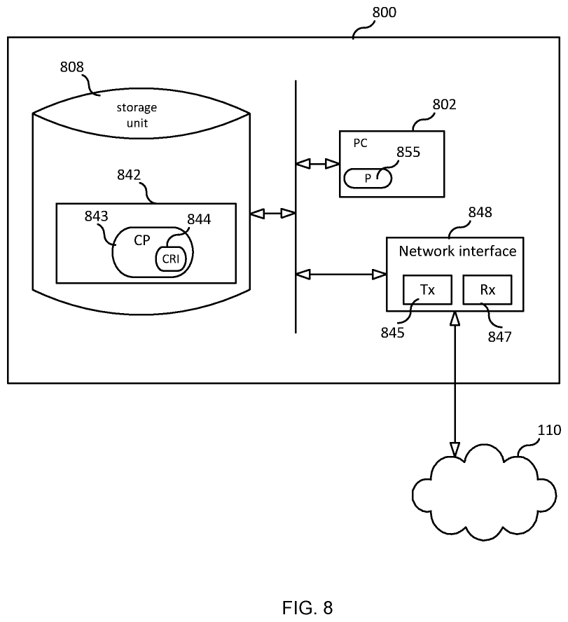

FIG. 8 is a block diagram of network node 800, according to some embodiments, that can implement any one or more of the network nodes described herein. That is, network node 800 can perform any of the above described methods. As shown in FIG. 8, network node 800 may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., network node 800 may be a distributed computing apparatus); at least one network interface 848 comprising a transmitter (Tx) 845 and a receiver (Rx) 847 for enabling network node 800 to transmit data to and receive data from other nodes connected to a network 110 (e.g., an Internet Protocol (IP) network) to which network interface 848 is connected (directly or indirectly) (e.g., network interface 848 may be wirelessly connected to the network 110, in which case network interface 848 is connected to an antenna arrangement); and a storage unit (a.k.a., “data storage system”) 808, which may include one or more non-volatile storage devices and/or one or more volatile storage devices. In embodiments where PC 802 includes a programmable processor, a computer readable medium (CRM) 842 may be provided. CRM 842 stores a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes network node 800 to perform steps described herein (e.g., steps described herein with reference to the flow charts). In other embodiments, network node 800 may be configured to perform steps described herein without the need for code. That is, for example, PC 802 may consist merely of one or more ASICs. Hence, the features of the embodiments described herein may be implemented in hardware and/or software.

### Summary of Various Embodiments

1. A method 600 (see FIG. 6) for transmitting a data object to a network node via a network, the method comprising: obtaining (s602) at least one of: i) information indicating the size of the data object, ii) network state information for the network (e.g., network load information and/or information indicating the amount of available resources), or iii) state information for the network node (e.g., a power savings configuration); determining (s604), based on the obtained information, at least one of: 1) a delay tolerant, DT, configuration for the transmission of the data object, wherein the determined DT configuration comprises a set of parameter values, or 2) a schedule for the transmission of the data object; and transmitting the data object to the network node based on i) the determined DT configuration and/or ii) the determined schedule.

2. The method of Embodiment 1, wherein the obtaining comprises: i) obtaining the information indicating the size of the data object, ii) obtaining the network state information for the network, and iii) obtaining the state information for the network node, and the determination of the DT configuration is based on the size of the data object, the network state information, and the state information for the network node, or the determination of the schedule is based on the size of the data object, the network state information, and the state information for the network node.

3. The method of Embodiment 1 or 2, wherein the method comprises selecting the DT configuration for the transmission of the data object, and selecting the DT configuration for the transmission of the data object comprises choosing a DT configuration from a set of predefined DT configurations, wherein each DT configuration included in the set of predefined DT configurations comprise a set of parameter values.

4. The method of Embodiment 3, wherein the set of predefined DT configurations comprises a first DT configuration and a second DT configuration, the first DT configuration is associated with a first data object size threshold value, T1s.

5. The method of Embodiment 4, wherein choosing a DT configuration from the set of predefined DT configurations comprise comparing a value S to T1_s, wherein Sis the determined size of the data object.

6. The method of Embodiment 5, wherein choosing the DT configuration comprises choosing the first DT configuration as a result of determining that a condition is satisfied, and the condition is satisfied when S>T1_s and zero or more other conditions are satisfied.

7. The method of Embodiment 6, comprising obtaining a network load value, L, indicating a load for the network, wherein the condition is satisfied when S>T1_s and L>T1_1 and zero or more other conditions are satisfied, and T1_1 is a predefined load threshold value.

8. The method of any one of Embodiments 1-7, wherein transmitting the data object to the network node based on i) the determined DT configuration or ii) the determined schedule comprises: at a first point in time, transmitting a first portion of the data object to the network node; choosing a second point in time at which to transmit a second portion of the data object; and at the second point in time, transmitting the second portion of the data object to the network node, wherein the second point in time is chosen based on i) a inactivity timer parameter value included in the determined DT configuration or the determined schedule.

9. The method of Embodiment 8, wherein transmitting the first portion of the data object to the network node comprises transmitting to the network node a first Static Context Header Compression (SCHC) fragment message that comprises the first portion of the data object, and transmitting the second portion of the data object to the network node comprises transmitting to the network node a second SCHC fragment message that comprises the second portion of the data object.

10. The method of Embodiment 9, wherein the method comprises selecting a DT configuration, and both the first and second SCHC fragment message comprises a fragment header that contains a DT configuration identifier (DTC-ID) that identifies the determined DT configuration.

11. A method 700 (see FIG. 7) for transmitting a data object to a network node via a network, the method comprising: determining (s702) the size of the data object; transmitting (s704) to the network node a first message indicating the determined size of the data object; receiving (s706) a second message transmitted by the network node, the second message indicating a delay tolerant (DT) configuration for the transmission of the data object, wherein the indicated DT configuration comprises a set of parameter values; and transmitting (s708) the data object to the network node based on the indicated DT configuration.

12. The method of any one of Embodiments 1-11, wherein the set of parameter values comprises at least one of: an inactivity timer value, or an acknowledgement (ACK) mode indicator specifying an ACK mode.

13. The method of any one of claims 1-12, wherein the network is a radio access network.

14. The method of claim 2, wherein the network node has a set of available DT configurations, and the determination is further based on the set of DT configurations available at the network node.

15. The method of claim 7, wherein the network load value indicates an expected network load, or the network load value indicates a current network load.

16. A computer program (843) comprising instructions (844) which when executed by processing circuitry (802) of a network node (800) causes the network node to perform the method of any one of embodiments 1-15.

17. A carrier containing the computer program of claim 16, wherein the carrier is one of an electronic signal, an optical signal, a radio signal, and a computer readable storage medium (842).

18. A network node (800), the network node being configured to perform the method of any one of Embodiments 1-15.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method, performed by a first network node, for transmitting a data object to a second network node via a network, wherein the second network node has a set of available delay tolerant configurations, the method comprising:
obtaining: i) information indicating the size of the data object, ii) network state information for the network, and/or iii) state information for the second network node;
based on i) the obtained information and ii) the set of DT configurations available at the second network node, determining:
i) a DT configuration for the transmission of the data object, wherein the determined DT configuration comprises a set of parameter values, and/or
ii) a schedule for the transmission of the data object; and
transmitting the data object to the second network node based on a) the determined DT configuration and/or b) the determined schedule.

2-3. (canceled)

4. The method of claim 1, wherein
the method comprises determining a DT configuration for the transmission of the data object, and
determining the DT configuration for the transmission of the data object comprises choosing a DT configuration from a set of predefined DT configurations, wherein each DT configuration included in the set of predefined DT configurations comprise a set of parameter values.

5. The method of claim 4, wherein
the set of predefined DT configurations comprises a first DT configuration and a second DT configuration,
the first DT configuration is associated with a first data object size threshold value, T1s.

6. The method of claim 5, wherein choosing a DT configuration from the set of predefined DT configurations comprise comparing a value S to T1_s, wherein S is the determined size of the data object.

7. The method of claim 6, wherein
choosing the DT configuration comprises choosing the first DT configuration as a result of determining that a condition is satisfied, and
the condition is satisfied when S>T1_s and zero or more other conditions are satisfied.

8. The method of claim 7, comprising obtaining a network load value, L, indicating a load for the network, wherein
the condition is satisfied when S>T1_s and L>T1_1 and zero or more other conditions are satisfied, and
T1_1 is a predefined load threshold value.

9. The method of claim 8, wherein
the network load value indicates an expected network load, or
the network load value indicates a current network load.

10. The method of claim 1, wherein transmitting the data object to the second network node based on i) the determined DT configuration or ii) the determined schedule comprises:
at a first point in time, transmitting a first portion of the data object to the second network node;
choosing a second point in time at which to transmit a second portion of the data object; and
at the second point in time, transmitting the second portion of the data object to the second network node,
wherein
the second point in time is chosen based on i) a inactivity timer parameter value included in the determined DT configuration or the determined schedule.

11. The method of claim 10, wherein
transmitting the first portion of the data object to the second network node comprises transmitting to the second network node a first Static Context Header Compression fragment message that comprises the first portion of the data object, and
transmitting the second portion of the data object to the second network node comprises transmitting to the second network node a second SCHC fragment message that comprises the second portion of the data object.

12. The method of claim 11, wherein
the method comprises selecting a DT configuration, and
both the first and second SCHC fragment message comprises a fragment header that contains a DT configuration identifier that identifies the determined DT configuration.

13. The method of claim 1, wherein the set of parameter values comprises:
an inactivity timer value, and/or
an acknowledgement, ACK, mode indicator specifying an ACK mode.

14. The method of claim 1, wherein the network is a radio access network.

15. A method performed by a first network node for transmitting a data object to a second network node via a network, the method comprising:
determining the size of the data object;
transmitting to the second network node a first message indicating the determined size of the data object;
receiving a second message transmitted by the second network node, the second message indicating a delay tolerant, DT, configuration for the transmission of the data object, wherein the indicated DT configuration comprises a set of parameter values; and
transmitting the data object to the second network node based on the indicated DT configuration.

16. The method of claim 15, wherein the set of parameter values comprises:
an inactivity timer value, and/or
an acknowledgement, ACK, mode indicator specifying an ACK mode.

17. The method of claim 15, wherein the network is a radio access network.

18-19. (canceled)

20. A first network node for transmitting a data object to a second network node via a network, wherein the second network node has a set of available delay tolerant configurations, the first network node being configured to:
obtain: i) information indicating the size of the data object, ii) network state information for the network, and/or iii) state information for the second network node;
based on i) the obtained information and ii) the set of DT configurations available at the second network node, determine:
i) a DT configuration for the transmission of the data object, wherein the determined DT configuration comprises a set of parameter values, and/or
ii) a schedule for the transmission of the data object; and
transmit the data object to the second network node based on i) the determined DT configuration and/or ii) the determined schedule.

21. (canceled)

22. A first network node for transmitting a data object to a second network node via a network, the first network node being configured to:
determine the size of the data object;
transmit to the second network node a first message indicating the determined size of the data object;
receive a second message transmitted by the second network node, the second message indicating a delay tolerant configuration for the transmission of the data object, wherein the indicated DT configuration comprises a set of parameter values; and
transmit the data object to the second network node based on the indicated DT configuration.

23. (canceled)

24. The first network node of claim 22, wherein
the first network node is a user equipment, and
the second network node is an access point or a core network node.

25. The first network node of claim 20, wherein
the first network node is a user equipment, and
the second network node is an access point or a core network node.
